(19) United States
(12) Patent Application Publication
(10) Pub. No.: US 2024/0286502 A1
(43) Pub. Date: Aug. 29, 2024

(54) INTEGRATED CHARGING AND DISCHARGING APPARATUS

(71) Applicants: Hyundai Motor Company, Seoul (KR); Kia Corporation, Seoul (KR); Yura Corporation Co., Ltd., Seongnam-si (KR)

(72) Inventors: Byung-Chul Sung, Gwacheon-si (KR); Woo-Won Jung, Osan-si (KR); Seong-Jae Lee, Osan-si (KR)

(21) Appl. No.: 18/354,311

(22) Filed: Jul. 18, 2023

(30) Foreign Application Priority Data
Feb. 23, 2023 (KR) 10-2023-0024144

(51) Int. Cl. B60L 53/16; B60L 53/62

(52) U.S. Cl. CPC B60L 53/16; B60L 53/62

(57) ABSTRACT

An embodiment integrated charging and discharging apparatus includes an outlet configured to be inserted into and engaged with an inlet of a vehicle and a gender configured to be inserted into a distal end of the outlet in a removable manner and configured to switch a charging state to a discharging state or the discharging state to the charging state.

### CROSS-REFERENCE TO RELATED APPLICATIONS

This application claims the benefit of Korean Patent Application No. 10-2023-0024144, filed on Feb. 23, 2023, which application is hereby incorporated herein by reference.

### TECHNICAL FIELD

Exemplary embodiments of the present disclosure relate to a charging apparatus.

### BACKGROUND

Generally, in the case of an electric vehicle to which a two-way on-board charger (OBC) is applied, charging and discharging are possible. In other words, power is supplied to the outside using a vehicle-to-load (V2L) function.

In this case, when a vehicle is currently charged, a charging cable is connected to an inlet of the vehicle to perform charging, and when discharging to supply power to an external device, a discharge outlet is inserted into the inlet of the vehicle for use. That is, since the plug of the external device is connected during use, a separate discharging outlet should be accommodated in the vehicle during discharging.

In other words, in order to use an outdoor V2L, a driver should select a separate outlet option for discharging and pay for the separate outlet option. In addition, there is a problem in that the separate discharging outlet should always be accommodated and stored.

### SUMMARY

Exemplary embodiments of the present disclosure relate to a charging apparatus. Particular embodiments relate to a charging apparatus having an integrated outlet for charging and discharging.

An embodiment of the present disclosure provides a charging apparatus capable of charging a vehicle and supplying power to an external component through a single outlet.

Another embodiment of the present disclosure provides a charging apparatus capable of using both charging and discharging functions with only a charging cable without a separate discharging outlet.

Other objects and advantages of embodiments of the present disclosure can be understood by the following description and become apparent with reference to the exemplary embodiments of the present disclosure. Also, it is obvious to those skilled in the art to which the present disclosure pertains that the objects and advantages of embodiments of the present disclosure can be realized by the means as claimed and combinations thereof.

In accordance with an embodiment of the present disclosure, there is provided a charging apparatus capable of charging a vehicle and supplying external power through a single outlet.

The charging apparatus may include an outlet inserted into and engaged with an inlet of a vehicle and a gender inserted into a distal end of the outlet in a removable manner and configured to switch charging to discharging or discharging to charging.

In this case, the outlet may include a plurality of lines, each line having one end connected to a terminal provided in an inner housing, an integrated switching part configured to perform the charging or the discharging, a changeover switching part configured to switch the charging to the discharging or the discharging to the charging, and a gender fastening part connected to the gender and the other end of each of the plurality of lines.

In addition, the integrated switching part may include an on-off switch connected to one of the plurality of lines and a plurality of resistors connected to the on-off switch in series and in parallel.

In addition, the plurality of resistors may include a first resistor connected to the on-off switch in parallel, a second resistor connected to the first resistor in parallel, a third resistor connected to the first resistor in series, and a fourth resistor connected to the third resistor in parallel.

In addition, a magnitude of a resistance value may be the second resistor>the first resistor>the third resistor>the fourth resistor.

In addition, the changeover switching part may include a charging switch connected to the integrated switching part and configured to perform the charging, a discharging switch disposed parallel to the charging switch, connected to the integrated switching part, and configured to perform the discharging, and a trigger configured to turn the charging switch or the discharging switch on or off.

In addition, during the charging, the on-off switch may be turned off, the charging switch may be turned on, and the discharging switch may be turned off.

In addition, during the discharging, the on-off switch may be turned on, the charging switch may be turned off, and the discharging switch may be turned on.

In addition, the trigger may be moved in a horizontal direction to turn the charging switch or the discharging switch on or off.

In addition, the trigger may have a T shape.

In addition, the gender may include a charging gender and a discharging gender.

In addition, the charging gender may be integrally formed with an assembling part formed at the one end of the connection cable.

In addition, the charging gender may be engaged with an assembling part formed at the one end of the connection cable in an assembling manner.

In addition, a groove into which the discharging gender is inserted to perform the discharging may be formed in the gender fastening part.

In addition, a concave portion, which is similar to the groove, may be formed at one end of the charging gender to perform the charging.

In addition, a protrusion inserted into the groove may be formed at one end of the discharging gender.

In addition, an external outlet may be formed at the other end of the discharging gender to supply power to an external component.

In addition, the discharging gender may include a display indicating whether the discharging is possible and an operating switch configured to turn on a discharging function.

In addition, the discharging gender may include a temperature switch configured to cut off power supplied to the operating switch when a temperature reaches a specific temperature.

In accordance with another embodiment of the present disclosure, there is provided an integrated charging and discharging apparatus including an outlet inserted into and engaged with an inlet of a vehicle, a charging gender which is inserted into and engaged with a distal end of the outlet for charging and is separable from the outlet, a connection cable having one end integrally formed with the charging gender, a control box connected to the other end of the connection cable, and a plug assembly connected to the control box.

In this case, the outlet may include an integrated switching part configured to perform the charging or the discharging, a changeover switching part configured to switch the charging to the discharging or the discharging to the charging, and a gender fastening part engaged with and connected to the charging gender.

### BRIEF DESCRIPTION OF THE DRAWINGS

FIG. 1 is a perspective view illustrating an integrated charging and discharging apparatus according to one embodiment of the present disclosure.

FIG. 2 is a block diagram illustrating a configuration of an outlet of the integrated charging and discharging apparatus shown in FIG. 1.

FIG. 3 is a circuit diagram to which a discharging gender is applied according to one embodiment of the present disclosure.

FIG. 4 is a circuit diagram to which a charging gender is applied according to another embodiment of the present disclosure.

FIG. 5 is a perspective view illustrating the integrated charging and discharging apparatus to which a charging gender shown in FIG. 1 is applied.

FIG. 6 is a perspective view illustrating the integrated charging and discharging apparatus to which a discharging gender shown in FIG. 1 is applied.

### DETAILED DESCRIPTION OF ILLUSTRATIVE EMBODIMENTS

The above and other objectives, features, and advantages of embodiments of the present disclosure will be described in detail with reference to the accompanying drawings, and therefore, the technical spirit of the present disclosure can be easily implemented by those skilled in the art.

Also, in the following description of embodiments of the present disclosure, when a detailed description of the known related art is determined to unnecessarily obscure the gist of the embodiments of the present disclosure, the detailed description thereof will be omitted.

Hereinafter, exemplary embodiments of the present disclosure will be described in detail with reference to the accompanying drawings. In the drawings, the same reference numeral refers to the same or similar component.

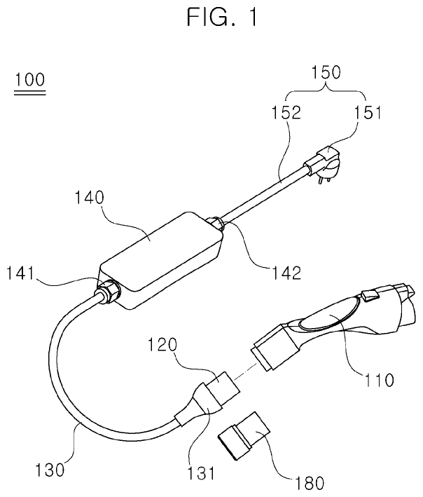

FIG. 1 is a perspective view illustrating an integrated charging and discharging apparatus 100 according to one embodiment of the present disclosure. Referring to FIG. 1, the integrated charging and discharging apparatus 100 may include an outlet 110, genders 120 and 180 inserted into a distal end of the outlet 110 in a removable manner, a connection cable 130 selectively connected to the genders 120 and 180, a control box 140 connected to the connection cable 130, and a plug assembly 150.

Terminals such as a charging terminal (not shown) and a ground terminal (not shown) which are fixed to an inner housing formed inside a case are provided in the outlet 110. That is, the outlet 110 is coupled to an inlet (not shown) installed in the vehicle. Plastic, engineering plastic, or the like may be mainly used as a material for the case and the inner housing.

The genders 120 and 180 include a charging gender 120 and a discharging gender 180. That is, the charging gender 120 is connected to an assembling part 131 formed at a distal end of the connection cable 130 in a removable manner. That is, one end of the charging gender 120 is connected to the assembling part 131, and the other end thereof is connected to the outlet 110.

Alternatively, the charging gender 120 may be integrally formed with the assembling part 131. Alternatively, the charging gender 120 and the assembling part 131 may be engaged with each other in an assembly method. In this case, a structure may be used in which a groove (not shown) may be formed in the assembling part 131 and a portion of the charging gender 120 may be closely inserted into the groove.

The distal end of the connection cable 130 is connected to the control box 140. The control box 140 includes a circuit board (not shown) for performing a short-circuit protection function, a charging control function, and a monitoring function. Of course, fuses, electronic circuits, microchips, circuit breakers, and the like may be provided on the circuit board.

A first fixer 141 for fixing the distal end of the connection cable 130 without juddering may be provided at one end of the control box 140 and a second fixer 142 for fixing a distal end of the plug cable 152 of the plug assembly 150 may be provided at the other end of the control box 140. Rubber may be used as materials for the fixers 141 and 142.

The plug assembly 150 includes a plug 151 and the plug cable 152 connected to the plug 151. The plug 151 is a vehicle charging plug for connecting to a household outlet. In this case, slow charging is generally used.

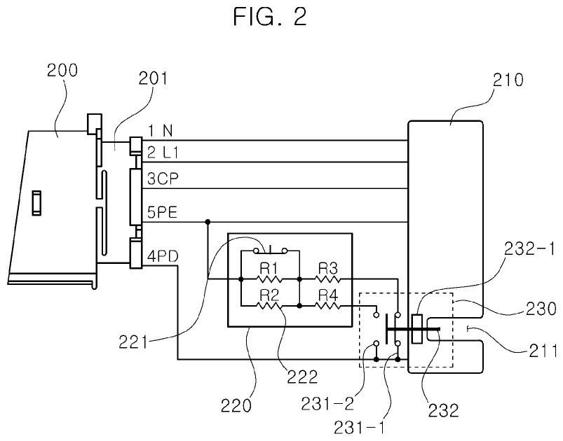

FIG. 2 is a block diagram illustrating a configuration of the outlet 110 of the integrated charging and discharging apparatus shown in FIG. 1. Referring to FIG. 2, the outlet 110 may include an inner housing 200 which is formed inside the case and which has a terminal 201, lines 1, 2, 4, 3, and 5 connected to the terminal 201, an integrated switching part 220 configured to selectively perform charging or discharging, a changeover switching part 230 configured to switch charging to discharging or vice versa, and a gender fastening part 210 connected to the gender 120 or 180.

A first line 1 and a second line 2 may be used as a power line L or a neutral line N, a third line 3 may be used for transmission of a control point (CP) signal, a fifth line 5 may be used for transmission of a protective earth (PE) signal, and a fourth line 4 may be used for transmission of a proximity detection (PD) signal.

The CP signal may be a signal for requesting a start or stop of power transmission or for controlling an amount of power. The CP signal may be generated by a CP generator (not shown) provided in an electric vehicle supply equipment (EVSE) or in a charger (not shown) of a vehicle.

The CP signal may be input to a pilot function logic in a charging apparatus (not shown) of an electric vehicle (not shown). To this end, when the CP signal is input, a switch (not shown) in the charging apparatus (not shown) may be closed.

The PD signal is to confirm whether the outlet 110 is plugged into a vehicle charging port (not shown). In other words, when a PD port (not shown) of the vehicle comes into contact with the fourth line 4, a proximity detection logic operates. This is to limit movement of the vehicle when the outlet 110 is plugged into an inlet (not shown) of the vehicle. In addition, the PE signal is for a protective conductor and a ground with respect to a CP.

The integrated switching part 220 performs a charging or discharging function. To this end, the integrated switching part 220 includes an on-off switch 221 and resistors 222 connected to the on-off switch 221 in series and in parallel. The on-off switch 221 is a push switch and is generally maintained in an “OFF” state during charging and is in an “ON” state during discharging. That is, when a driver does not turn the on-off switch 221 on, the “OFF” state is maintained.

The resistors 222 include a first resistor R1 connected to the on-off switch 221 in parallel, a second resistor R2 connected to the first resistor R1 in parallel, a third resistor R3 connected to the first resistor R1 in series, and a fourth resistor R4 connected to the third resistor R3 in parallel. A magnitude of a resistance value is the second resistor R2>the first resistor R1>the third resistor R3>the fourth resistor R4.

The changeover switching part 230 performs a function of switching charging to discharging or vice versa. To this end, the changeover switching part 230 includes a charging switch 231-1, a discharging switch 231-2 disposed parallel to the charging switch 231-1, and a trigger 232 configured to turn the charging switch 231-1 or the discharging switch 231-2 on or off.

In other words, during charging, the on-off switch 221 is turned off, the charging switch 231-1 is turned on, and the discharging switch 231-2 is turned off. Therefore, a circuit including the first resistor R1 and the third resistor R3 is used.

Conversely, during discharging, the on-off switch 221 is turned on, the charging switch 231-1 is turned off, and the discharging switch 231-2 is turned on. Therefore, a circuit including the second resistor R2 and the fourth resistor R4 is used.

The trigger 232 performs a function of turning the charging switch 231-1 and/or the discharging switch 231-2 on or off. In particular, the trigger 232 is installed in a groove 211 formed in the gender fastening part 210 and has a structure moving in a horizontal direction. Alternatively, an elastic member 232-1 may be provided in the trigger 232.

Therefore, the trigger 232 has a structure of being compressed when the discharging gender 180 is inserted into the gender fastening part 210 and of restoring again when the discharging gender 180 is separated from the gender fastening part 210. A spring or sponge may be used as a material of the elastic member 232-1. Of course, to this end, a hook protrusion (not shown) of a horizontal bar shape may be formed in the trigger 232, and a groove (not shown) may be formed inside the gender fastening part 210.

Alternatively, a hook protrusion of a vertical bar shape is formed at a distal end of the trigger 232. That is, the trigger 232 may have a T-shape formed of a horizontal bar and a vertical bar. The vertical bar shape may be provided as a plurality of vertical bar shapes formed at regular intervals, and a metal thin film may be attached to a surface of each vertical bar shape for conduction. Therefore, two contact points of the charging switch 231-1 and the discharging switch 231-2 may be contacted or separated.

Terminals (not shown) connected to the lines 1, 2, 3, 4, and 5 are provided in the gender fastening part 210. The terminals (not shown) are engaged with and connected to terminals (not shown) in the gender 120 or 180. To this end, one side may be a male terminal and the other side may be a female terminal. For example, the terminal of the gender fastening part 210 may be a female terminal, and the terminal of the gender 120 or 180 may be a male terminal. Therefore, these terminals may be inserted and engaged in a sliding manner.

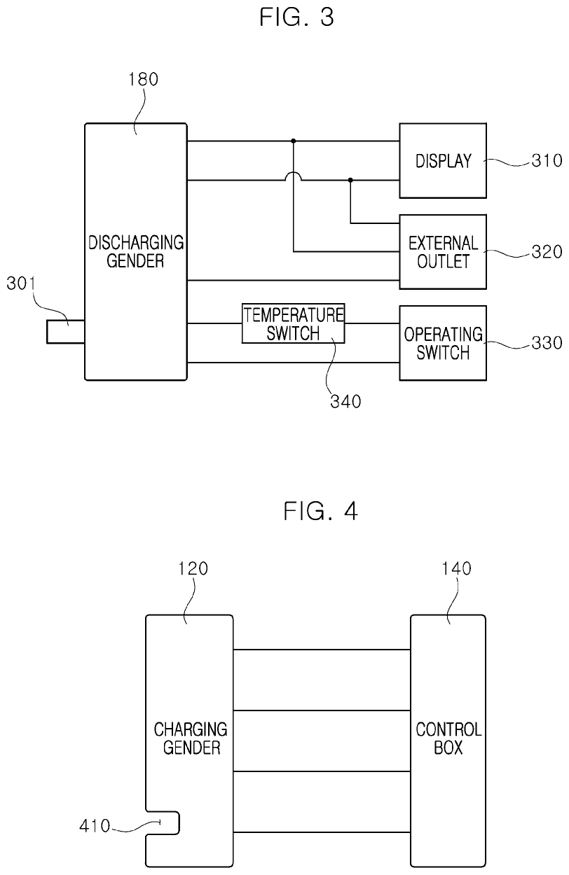

FIG. 3 is a circuit diagram to which the discharging gender 180 is applied according to one embodiment of the present disclosure. Referring to FIG. 3, a protrusion 301 inserted into the groove 211 is formed at one end of the discharging gender 180. A shape of the groove 211 may be various shapes such as a circular shape, a quadrangular shape, and a hexagonal shape. According to the shape of the groove 211, the protrusion 301 may have various shapes such as a circular shape, a quadrangular shape, and a hexagonal shape.

In addition, the discharging gender 180 may include a display 310 indicating whether discharging is possible, an external outlet 320 configured to supply power to an external component, and an operating switch 330 configured to turn a discharging function on. Of course, a temperature switch 340 may be provided between the discharging gender 180 and the operating switch 330. That is, the temperature switch 340 performs a function of cutting off power supplied to the operating switch 330. The temperature switch 340 may be a bimetal or the like. That is, when a temperature reaches a predetermined temperature (for example, 40° C.), the temperature switch 340 becomes short-circuited.

The display 310 performs a displaying function to allow the driver to check whether discharging is possible. A light-emitting diode (LED) is mainly used for the display 310, and a micro LED and a mini LED may be used. The display 310 may be installed on an end surface of an exterior of the discharging gender 180 or on a surface of the exterior thereof.

The external outlet 320 at one end of the discharging gender 180 is connected to an external plug (not shown) to supply vehicle power to an external load. That is, an external plug (not shown) is inserted into the external outlet 320.

Meanwhile, FIG. 3 shows an example in which five pins are shared with seven pins. That is, the first to fifth lines 1 to 5 (see FIG. 2) are formed with seven (7) lines, and the first and second lines 1 and 2 are commonly connected to the display 310 and the external outlet 320.

FIG. 4 is a circuit diagram to which a charging gender 120 is applied according to another embodiment of the present disclosure. Referring to FIG. 4, a concave portion 410 similar to the groove 211 is formed at one end of the charging gender 120. A shape of the concave portion 410 may be various shapes such as a circular shape, a quadrangular shape, and a hexagonal shape. Therefore, when the charging gender 120 is used, the trigger 232 does not operate in the changeover switching part 230. Thus, only the charging switch 231-1 is turned on, and the discharging switch 231-2 is maintained in an off state.

The charging gender 120 is connected to the control box 140 through the connection cable 130 (see FIG. 1). Of course, terminals (not shown) are provided in the charging gender 120. These terminals are coupled to the gender fastening part 210 in a removable manner. To this end, the terminal of the charging gender 120 may be formed as a male terminal and the terminal of the gender fastening part 210 may be formed as a female terminal. Therefore, these terminals may be inserted, engaged, and separated in a sliding manner.

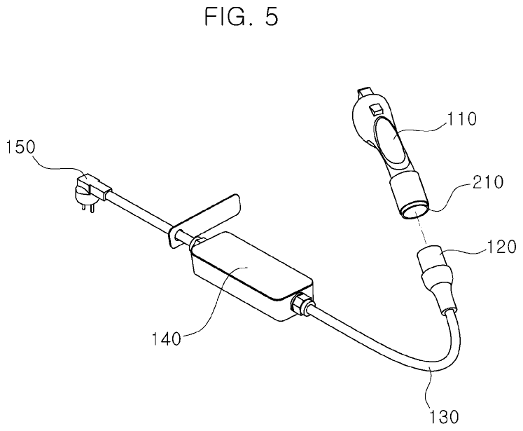

FIG. 5 is a perspective view illustrating the integrated charging and discharging apparatus to which the charging gender 120 shown in FIG. 1 is applied. Referring to FIG. 5, the charging gender 120 is inserted into and engaged with the gender fastening part 210 provided at the distal end of the outlet 110. The charging gender 120 is integrally formed with the connection cable 130. Alternatively, the charging gender 120 may be connected to the connection cable 130 in a removable manner.

It is a structure in which the connection cable 130 and the outlet 110, which are basically provided, are separated from each other. In this case, the charging gender 120, the connection cable 130, the control box 140, and the plug assembly 150 may be formed as one assembly.

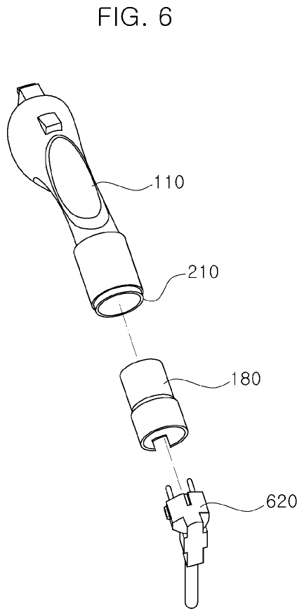

FIG. 6 is a perspective view illustrating the integrated charging and discharging apparatus to which the discharging gender 180 shown in FIG. 1 is applied. Referring to FIG. 6, the discharging gender 180 is inserted into and engaged with the gender fastening part 210 provided at the distal end of the outlet 110. In other words, in FIG. 5, the charging gender 120 is separated from the gender fastening part 210 provided at the distal end of the outlet 110 in a sliding manner, and the discharging gender 180 is engaged with the gender fastening part 210.

In this state, by engaging a plug 620 of a home appliance with the discharging gender 180, power may be supplied from a vehicle (not shown) to the home appliance.

In accordance with embodiments of the present disclosure, the existing charging/discharging dualized specifications can be unified into an integrated outlet.

In addition, in accordance with embodiments of the present disclosure, there is another effect in that a common portion between the existing charging outlet and the existing discharging outlet is integrated so that improvement effects such as parts reduction, cost reduction, and optimized product proposal can be expected.

In addition, in accordance with embodiments of the present disclosure, there is still another effect in that an integrated circuit solution can be applied to a difference between resistor circuits.

In addition, in accordance with embodiments of the present disclosure, there is yet another effect in that a recognition problem of two types of outlets of a vehicle due to integration can be solved by a simplified solution structure between a gender and a switch.

While embodiments of the present disclosure have been described with reference to the accompanying drawings, it will be apparent to those skilled in the art that various changes and modifications can be made without departing from the spirit and scope of the present disclosure without being limited to the exemplary embodiments disclosed herein. Accordingly, it should be noted that such alternations or modifications fall within the claims of the present disclosure, and the scope of the present disclosure should be construed on the basis of the appended claims.

What is claimed is:

1. An integrated charging and discharging apparatus, the apparatus comprising:
an outlet configured to be inserted into and engaged with an inlet of a vehicle; and
a gender configured to be inserted into a distal end of the outlet in a removable manner and configured to switch a charging state to a discharging state or the discharging state to the charging state.

2. The apparatus of claim 1, wherein the outlet comprises:
a plurality of lines, each line of the plurality of lines having a first end connected to a terminal provided in an inner housing;
an integrated switching part configured to perform charging or discharging;
a changeover switching part configured to switch the charging state to the discharging state or the discharging state to the charging state; and
a gender fastening part connected to the gender and a second end of each line of the plurality of lines.

3. The apparatus of claim 2, wherein the integrated switching part comprises:
an on-off switch connected to one line of the plurality of lines; and
a plurality of resistors connected to the on-off switch in series and in parallel.

4. The apparatus of claim 3, wherein the plurality of resistors comprises:
a first resistor connected to the on-off switch in parallel;
a second resistor connected to the first resistor in parallel;
a third resistor connected to the first resistor in series; and
a fourth resistor connected to the third resistor in parallel.

5. The apparatus of claim 4, wherein a magnitude of a resistance value is the second resistor>the first resistor>the third resistor>the fourth resistor.

6. The apparatus of claim 3, wherein the changeover switching part comprises:
a charging switch connected to the integrated switching part and configured to perform the charging;
a discharging switch disposed parallel to the charging switch, connected to the integrated switching part, and configured to perform the discharging; and
a trigger configured to turn the charging switch or the discharging switch on or off.

7. The apparatus of claim 6, wherein, during the charging, the on-off switch is turned off, the charging switch is turned on, and the discharging switch is turned off.

8. The apparatus of claim 6, wherein, during the discharging, the on-off switch is turned on, the charging switch is turned off, and the discharging switch is turned on.

9. The apparatus of claim 6, wherein the trigger is moved in a horizontal direction to turn the charging switch or the discharging switch on or off.

10. The apparatus of claim 6, wherein the trigger has a T shape.

11. An integrated charging and discharging apparatus, the apparatus comprising:
an outlet configured to be inserted into and engaged with an inlet of a vehicle; and
a gender configured to be inserted into a distal end of the outlet in a removable manner and configured to switch a charging state to a discharging state or the discharging state to the charging state;
wherein the gender comprises a charging gender and a discharging gender; and
wherein the outlet comprises:
a plurality of lines, each line of the plurality of lines having a first end connected to a terminal provided in an inner housing;
an integrated switching part configured to perform charging or discharging;
a changeover switching part configured to switch the charging state to the discharging state or the discharging state to the charging state; and
a gender fastening part connected to the gender and a second end of each line of the plurality of lines.

12. The apparatus of claim 11, wherein the charging gender is integrally formed with an assembling part provided at a first end of a connection cable.

13. The apparatus of claim 11, wherein the charging gender is configured to be engaged with an assembling part provided at a first end of a connection cable in an assembling manner.

14. The apparatus of claim 11, wherein the gender fastening part comprises a groove into which the discharging gender is configured to be inserted to perform the discharging.

15. The apparatus of claim 14, wherein a concave portion is provided at a first end of the charging gender to perform the charging, the concave portion being similar to the groove.

16. The apparatus of claim 14, wherein a protrusion inserted into the groove is provided at a first end of the discharging gender.

17. The apparatus of claim 16, wherein an external outlet is provided at a second end of the discharging gender to supply power to an external component.

18. The apparatus of claim 17, wherein the discharging gender comprises:
a display configured to indicate whether the discharging is possible; and
an operating switch configured to turn on a discharging function.

19. The apparatus of claim 18, wherein the discharging gender comprises a temperature switch configured to cut off power supplied to the operating switch in response to a temperature reaching a specific temperature.

20. An integrated charging and discharging apparatus, the apparatus comprising:
an outlet configured to be inserted into and engaged with an inlet of a vehicle;
a charging gender configured to be inserted into and engaged with a distal end of the outlet for charging and separated from the outlet;
a connection cable having a first end integrally formed with the charging gender;
a control box connected to a second end of the connection cable; and
a plug assembly connected to the control box; and
wherein the outlet comprises:
an integrated switching part configured to perform the charging or discharging;
a changeover switching part configured to switch a charging state to a discharging state or the discharging state to the charging state; and
a gender fastening part engaged with and connected to the charging gender.
